(19) United States
(12) Patent Application Publication
(10) Pub. No.: US 2008/0235501 A1
(43) Pub. Date: Sep. 25, 2008

(54) Method For Detecting and Correcting Firmware Corruption

(76) Inventors: James Ray Bailey, Georgetown, KY (US); Christopher Wilson Case, Georgetown, KY (US); Vladimir Vinogradov, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/687,911

(22) Filed: Mar. 19, 2007

(51) Int. Cl. G06F 9/24

(52) U.S. Cl. 713/1

(57) ABSTRACT

A method for detecting and correcting firmware corruption in a system having a host communicatively coupled to an electronic apparatus, the electronic apparatus having a hardware unit communicatively coupled to a non-volatile memory, includes determining via the hardware unit whether firmware on the non-volatile memory is corrupted; if the firmware is determined to be corrupted, then: invoking a communication driver resident in the hardware unit to establish bi-directional communications between the host and the electronic apparatus; and initiating a firmware download from the host to update the firmware on the non-volatile memory to an uncorrupted state.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to an electronic apparatus, and more particularly, to a method for detecting and correcting firmware corruption.

2. Description of the Related Art

Typically a product that utilizes an embedded system, i.e., one that contains a combination of Application Specific Integrated Circuits (ASICs) and firmware, includes non-volatile memory. Firmware is software that is embedded in a hardware device, such as the non-volatile memory, e.g., flash memory. Firmware may be stored in flash memory, for example, so that the firmware can be loaded and ran in faster, volatile memory upon power-on. In a typical embedded system, such as that resident in a printer, the communications interface, e.g., universal serial bus (USB), is controlled by firmware. In some systems, for example, USB may be the only path of communications between a computer and the printer.

The firmware code is critical to the basic functionality of the product, thus any corruption of the non-volatile memory device will render the product unusable. In the case of a communications interface, if the firmware on the flash memory controlling the communications interface becomes corrupted, then the communications interface is rendered inoperable.

Restoring the firmware to the non-volatile memory often requires a special machine to write to the non-volatile memory. Typically, such a restoration would require the non-volatile memory to be either removed from the product and programmed, or would require access to special electrical interfaces, such as JTAG, to acquire control of the non-volatile memory for programming. Alternatively, the non-volatile memory may be removed and replaced by another with uncorrupted firmware. Any of the above-mentioned approaches can be difficult and quite time consuming.

For an end-user, the non-volatile memory, e.g., flash memory, is often corrupted during a firmware upgrade for the product because of interruption or bad communications to the product. Corruption of the flash memory effectively ends the life of the product in the field due to the difficulties in reprogramming the non-volatile memory. On a manufacturing line, firmware corruption of flash memory may account for failures during final assembly. While the assembled product with the corrupted firmware could be recovered by simply re-loading the firmware code onto the non-volatile memory, such is not economically feasible due to the difficulty and time it takes to perform the re-load.

### SUMMARY OF THE INVENTION

The present invention provides a method that automatically detects corruption of firmware in non-volatile memory and restores the non-volatile memory contents upon detection, which may be accomplished without access to special tools or unique electrical connections. This automatic recovery method may be available to both technicians on a manufacturing line and to an end user of the product.

The invention, in one form thereof, is directed to a method for detecting and correcting firmware corruption in a system having a host communicatively coupled to an electronic apparatus. The electronic apparatus has a hardware unit communicatively coupled to a non-volatile memory. The method includes determining via the hardware unit whether firmware on the non-volatile memory is corrupted; if the firmware is determined to be corrupted, then: invoking a communication driver resident in the hardware unit to establish bi-directional communications between the host and the electronic apparatus; and initiating a firmware download from the host to update the firmware on the non-volatile memory to an uncorrupted state.

The invention, in another form thereof, is directed to a method for facilitating firmware corruption detection in a system having a host communicatively coupled to an electronic apparatus, the electronic apparatus having a hardware unit communicatively coupled to a non-volatile memory. The method includes establishing a communication driver resident in the hardware unit to establish bi-directional communications between the electronic apparatus and the host.

The invention, in another form thereof, is directed to a method for detecting firmware corruption in a system having a host communicatively coupled to an electronic apparatus, the electronic apparatus having a hardware unit communicatively coupled to a non-volatile memory. The hardware unit includes a boot ROM for: querying the non-volatile memory for a signature word; and determining whether the signature word is in proper form. If the signature word is not in proper form, then the firmware in the non-volatile memory is deemed to be corrupted. If the signature word is in proper form, then the firmware in the non-volatile memory is downloaded to volatile memory, and a checksum is performed on the firmware downloaded to the volatile memory. If the checksum fails, then the firmware in the non-volatile memory is deemed to be corrupted. If the checksum passes, then the firmware downloaded to the volatile memory is executed.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of an exemplary system embodying the present invention;

FIG. 2 is a general flowchart depicting a method for detecting and correcting firmware corruption in the system of FIG. 1; and

FIG. 3 is a more detailed flowchart depicting a method for detecting and correcting firmware corruption in the system of FIG. 1.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention, and other alternative mechanical configurations are possible.

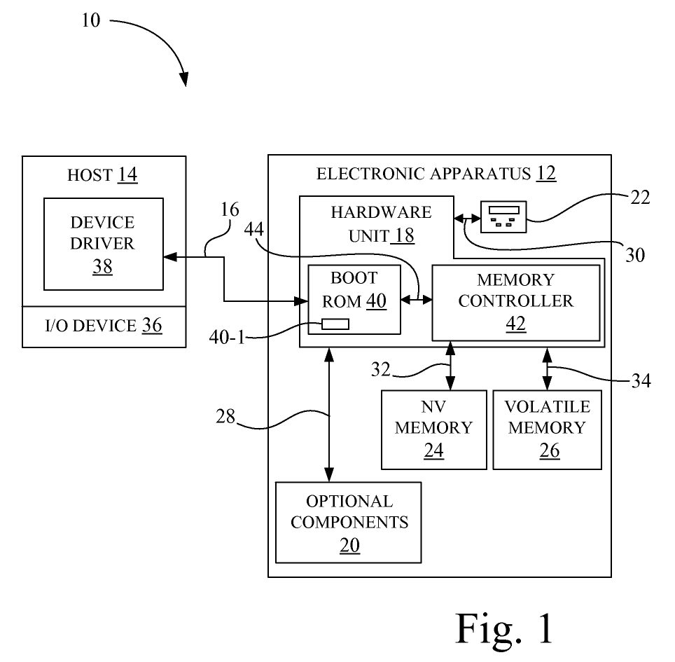

Referring now to the drawings and particularly to FIG. 1, there is shown a diagrammatic depiction of a system 10 embodying the present invention. System 10 includes an electronic apparatus 12 and a host 14.

Electronic apparatus 12 communicates with host 14 via a communications link 16. As used herein, the term “communications link” is used to generally refer to structure that facilitates electronic communication between multiple components, and may operate using wired or wireless technology. Communications link 16, for example, may be established by a direct cable connection, such as a universal serial bus (USB) cable; wireless connection; or by a network connection, such as for example an Ethernet local area network (LAN). Electronic apparatus 12 may communicate with host 14 via a standard communication protocol, such as for example, universal serial bus (USB), IEEE 802.1xx, or Ethernet.

Electronic apparatus 12 may take the form of, for example, an imaging apparatus, a portable music player, a digital camera, etc. As used herein, the term “imaging apparatus” means an apparatus used to form an image on a print medium, such as paper, transparency, fabric, etc., and may utilize, for example, one or more of the following exemplary print technologies: ink jet, dot matrix, dye sublimation, EP (e.g., laser), etc. An imaging apparatus may be, for example, a printer and/or copier, or an all-in-one (AIO) unit that includes a print engine, a scanner unit, and possibly a fax unit that incorporate multiple functions such as scanning, copying, faxing or printing capabilities in one device. An AIO unit is also known in the art as a multifunction machine.

In the example shown in FIG. 1, electronic apparatus 12 includes a hardware unit 18, optional components 20, a user interface 22, non-volatile (NV) memory 24 and volatile memory 26.

In an embodiment wherein electronic apparatus 12 is an image forming apparatus, optional components 20 may be, for example, a print engine that may utilize electrophotographic (e.g., laser) technology, ink jet technology, or other suitable printing technology.

Non-volatile (NV) memory 24 may be, for example, flash memory. Volatile memory 26 may be, for example, random access memory (RAM), such as dynamic RAM (DRAM).

In the present embodiment, hardware unit 18 communicates with optional components 20 via a communications link 28. Hardware unit 18 communicates with user interface 22 via a communications link 30. Hardware unit 18 communicates with NV memory 24 via a communications link 32. Hardware unit 18 communicates with volatile memory 26 via a communications link 34. Communications links 28, 30, 32 and 34 may be established, for example, by using standard electrical cabling or bus structures, or by wireless connection.

Host 14 may be, for example, a personal computer including an input/output (I/O) device 36, such as keyboard and display monitor. Host 14 further includes a processor, input/output (I/O) interfaces, memory, such as RAM, ROM, NVRAM, and a mass data storage device, such as a hard drive, CD-ROM and/or DVD units. Host 14 includes in its memory a software program including program instructions that function as a device driver 38, e.g., printer driver software, for electronic apparatus 12. Device driver 38 is in communication with hardware unit 18 of electronic apparatus 12 via communications link 16. Device driver 38 assists in facilitating bi-directional communication between electronic apparatus 12 and host 14. In addition, device driver 38 may provide firmware update code to non-volatile (NV) memory 24 via hardware unit 18.

Hardware unit 18 functions as a general controller, and is formed as a processor with associated memory, and may be in the form of one or more Application Specific Integrated Circuits (ASIC). The associated memory may include, for example, a boot ROM (read only memory) module 40, and associated random access memory (RAM). Boot ROM module 40 may be formed as part of the ASIC of hardware unit 18, or alternatively may be a separate electronic memory, hard drive, or CD or DVD drive convenient for use with hardware unit 18. Hardware unit 18 further includes a memory controller 42 communicatively coupled to NV memory 24 via communications link 32. Memory controller 42 is communicatively coupled to boot ROM module 40 via a communications link 44.

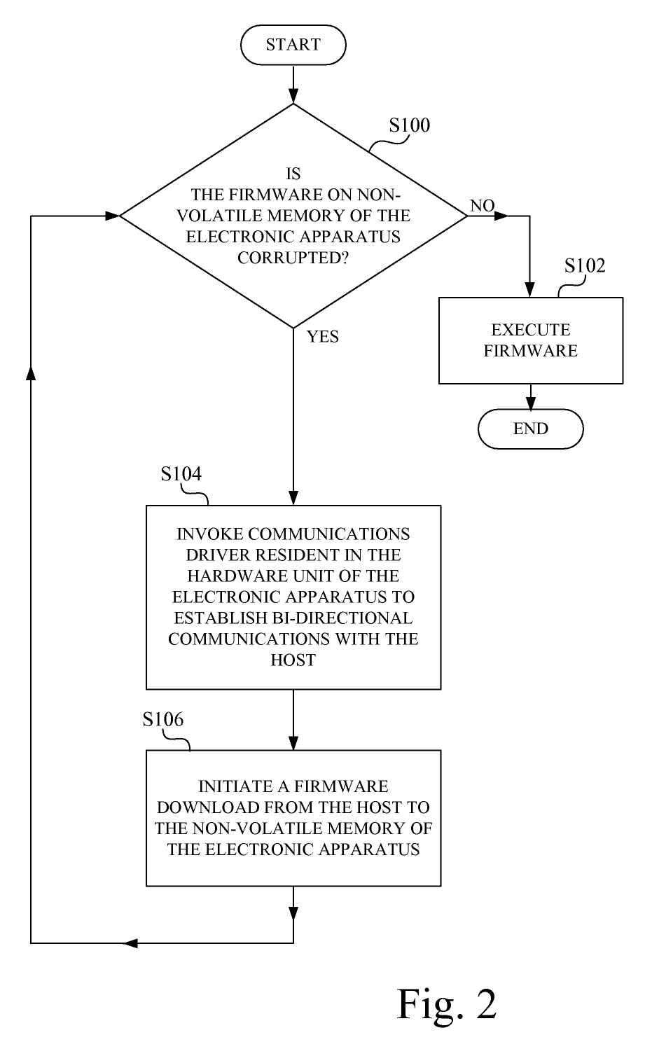

Referring now to FIG. 2, there is shown a general flowchart depicting a method for detecting and correcting firmware corruption in a system, e.g., system 10, in accordance with an embodiment of the present invention. The method may be performed automatically at a power on reset (POR) of electronic apparatus 12. Alternatively, the method may be performed at a manual initiation by a user of electronic apparatus 12, such as for example, by pressing a button on user interface 22.

At act S100, it is determined via hardware unit 18, e.g., boot ROM module 40 that is resident in hardware unit 18, whether firmware on NV memory 24 of electronic apparatus 12 is corrupted. During this determination, firmware on NV memory 24 may be downloaded to volatile memory 26.

If the determination at act S100 is NO, i.e., the firmware is not corrupted, then the process proceeds to act S102, wherein the firmware that has been downloaded from NV memory 24 to volatile memory 26 in electronic apparatus 12 is executed. After act S102, the process ends.

However, if the determination at act S100 is YES, i.e., the firmware is determined to be corrupted, then the process proceeds to act S104.

At act S104, a communication driver 40-1 resident in hardware unit 18 is invoked to establish bi-directional communications between host 14 and electronic apparatus 12. The communications driver may be resident, for example, in boot ROM module 40. The bi-directional communications may be facilitated, for example, by universal serial bus (USB) communications initiated by the communication driver 40-1 resident in hardware unit 18. For example, basic USB driver functionality is hard-coded in the ASIC, i.e., hardware unit 18, such that no device firmware in electronic apparatus 12 is required to enumerate USB on the host 14 and establish bi-directional communications. In one embodiment, for example, the USB driver is built into boot ROM module 40, with the hardware unit 18 being designed to handle the power-up sequence of the ASIC itself. A USB can be used to send commands to the ASIC to reprogram NV memory 24. The firmware itself can be sent from host 14 through the USB to the ASIC (i.e., hardware unit 18) and then into NV memory 24.

At act S106, host 14 initiates a firmware download from host 14 to update the firmware on NV memory 24 to an uncorrupted state. Thereafter, the process returns to act S100.

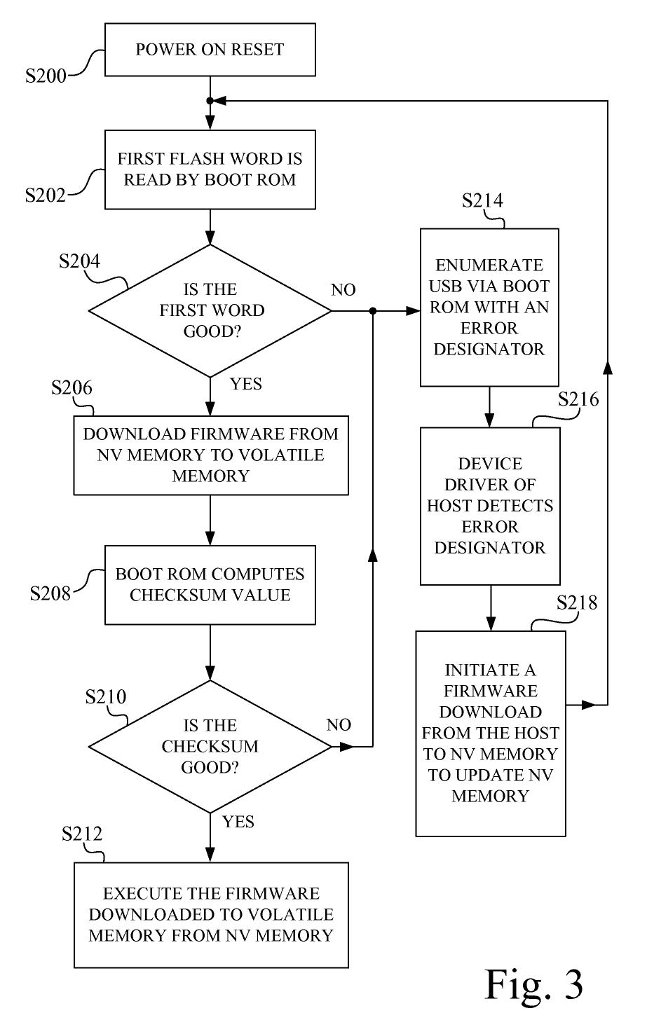

FIG. 3 is more detailed flowchart depicting a method for detecting and correcting firmware corruption, described in general above with respect to FIG. 2.

The method begins at act S200, with the initiation of a power on reset (POR) of electronic apparatus 12.

At act S202, hardware unit 18, e.g., boot ROM module 40, queries NV memory 24, e.g., flash memory, to read a signature word, e.g., a first flash word, stored in NV memory 24. The signature word identifies what type non-volatile memory, e.g., flash, is connected and if the non-volatile memory is programmed. The signature word may contain information in addition to that used in identifying the type of non-volatile memory.

At act S204, it is determined whether the signature word is in proper form, i.e., is good. For example, the signature word, e.g., the first word, from NV memory 24 may be compared to an expected value.

If at act S204 the determination is NO, i.e., the signature word is not in proper form, then the firmware in NV memory 24 is deemed to be corrupted, and the process proceeds to act S214. In other words, if the values do not match, then NV memory 24 is determined to be corrupted, and the boot loader code of boot ROM module 40 will retain control and begin execution of firmware load recovery routines beginning at act S214.

If at act S204 the determination is YES, i.e., the signature word is in proper form, then the process proceeds to act S206.

At act S206, firmware in NV memory 24 is downloaded to volatile memory 26, e.g., DRAM, under the control of memory controller 42.

At act S208, boot ROM module 40 performs a checksum computation on the firmware downloaded to volatile memory 26, e.g., DRAM, to compute a checksum. In other words, the checksum is calculated by hardware unit 18 (e.g., the ASIC), and more particularly by boot ROM module 40 in the present embodiment, during the download of the firmware from NV memory 24 to volatile memory 26.

At act S210, it is determined whether the checksum is good, i.e., has not failed the checksum test. In other words, the checksum is compared to an expected value.

If the determination at act S210 is YES, i.e., the checksum has not failed, then the process proceeds to act S212, wherein the firmware downloaded to volatile memory 26 in electronic apparatus 12 from NV memory 24 is executed in the normal fashion.

If the determination at act S210 is NO, i.e., the checksum has failed, then the firmware in NV memory 24 is deemed to be corrupted. For example, if this checksum does not match the checksum contained in the first page of the firmware downloaded, the firmware is determined to be corrupted, and the boot ROM module 40 will retain control and begin execution of firmware load recovery routines beginning at act S214. It will be realized that this process can take place with respect to each page or a predetermined number of pages of the firmware that is being downloaded.

Upon the determination of firmware corruption in either of acts S204 or S210, the process proceeds to act S214.

At act S214, the communication driver 40-1, e.g., a USB driver, in boot ROM module 40 resident in hardware unit 18 of electronic apparatus 12 sends a USB request, e.g., a USB enumeration, to host 14. The USB enumeration includes a unique error designator to indicate to host 14 that NV memory 24 in electronic apparatus 12 is corrupted. The unique error designator of the USB enumeration may be, for example, a unique device ID that is sent to host 14 so that host 14 will enumerate a different device than the original product (e.g., different ID, description string, etc.).

At act S216, device driver 38 of host 14 detects the unique designator of the USB enumeration.

At act S218, host 14 automatically initiates a firmware download from host 14 to NV memory 24 upon detection of the unique designator of the USB enumeration to update the firmware on NV memory 24 to an uncorrupted state. The firmware download may, for example, update NV memory 24 with the last known good firmware load via USB.

After act S218, the process returns to act S202, wherein the check for detection of the corruption of the firmware on NV memory 24 is repeated.

The above described methods facilitate an automatic recovery from corrupted firmware in electronic apparatus 12 without the necessity of alerting the end user that a problem was encountered. The methods may be used, for example, to reduce risks associated with user upgrades of a product's firmware in the field, and/or may be utilized to improve the manufacturing yield for electronic apparatus that have a corrupted first firmware load in flash memory at the factory.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for detecting and correcting firmware corruption in a system having a host communicatively coupled to an electronic apparatus, said electronic apparatus having a hardware unit communicatively coupled to a non-volatile memory, comprising:
determining via said hardware unit whether firmware on said non-volatile memory is corrupted;
if said firmware is determined to be corrupted, then:
invoking a communication driver resident in said hardware unit to establish bi-directional communications between said host and said electronic apparatus; and
initiating a firmware download from said host to update said firmware on said non-volatile memory to an uncorrupted state.

2. The method of claim 1, wherein said bi-directional communications is facilitated by universal serial bus (USB) communications initiated by said communication driver resident in said hardware unit.

3. The method of claim 2, wherein said communication driver resident in said hardware unit sends a USB enumeration to said host, said USB enumeration including a unique designator to indicate to said host that said non-volatile memory is corrupted.

4. The method of claim 3, wherein said host:
detects said unique designator of said USB enumeration; and
automatically initiates said firmware download from said host to said non-volatile memory upon detection of said unique designator of said USB enumeration.

5. The method of claim 1, wherein the act of determining whether firmware on said non-volatile memory is corrupted includes using said hardware unit for:
querying said non-volatile memory for a signature word; and
determining whether said signature word is in proper form, wherein if said signature word is not in proper form, then said firmware in said non-volatile memory is deemed to be corrupted.

6. The method of claim 1, wherein the act of determining whether firmware on said non-volatile memory is corrupted includes using said hardware unit for:
downloading firmware in said non-volatile memory to volatile memory; and
performing a check on said firmware downloaded to said volatile memory, wherein if said check fails, then said firmware in said non-volatile memory is deemed to be corrupted.

7. The method of claim 1, wherein the act of determining whether firmware on said non-volatile memory is corrupted includes using said hardware unit for:
querying said non-volatile memory for a signature word; and
determining whether said signature word is in proper form, wherein
if said signature word is not in proper form, then said firmware in said non-volatile memory is deemed to be corrupted, and
if said signature word is in proper form, then:
downloading firmware in said non-volatile memory to volatile memory; and
performing a checksum on said firmware downloaded to said volatile memory, wherein:
if said checksum fails, then said firmware in said non-volatile memory is deemed to be corrupted, and
if said checksum passes, then executing said firmware downloaded to said volatile memory.

8. The method of claim 1, wherein the method is performed automatically at a power on reset (POR) of said electronic apparatus.

9. The method of claim 1, wherein the method is performed at a manual initiation by a user of said electronic apparatus.

10. The method of claim 1, wherein said hardware unit is an application specific integrated circuit (ASIC).
A method for facilitating firmware corruption detection in a system having a host communicatively coupled to an electronic apparatus, said electronic apparatus having a hardware unit communicatively coupled to a non-volatile memory, comprising establishing a communication driver resident in said hardware unit to establish bi-directional communications between said electronic apparatus and said host.

12. The method of claim 11, wherein said communication driver is a USB driver, said bi-directional communications being facilitated by universal serial bus (USB) communications initiated by said USB driver resident in said hardware unit.

13. The method of claim 12, wherein during the establishing of said bi-directional communications said USB driver resident in said hardware unit sends a USB request to said host, said USB request including a unique designator to indicate to said host that said non-volatile memory is corrupted.

14. The method of claim 13, said host:
detecting said unique designator of said USB request; and
automatically initiating a firmware download from said host to said non-volatile memory upon detection of said unique designator of said USB request.

15. The method of claim 14, wherein said USB request is a USB enumeration.

16. The method of claim 11, wherein said hardware unit is an application specific integrated circuit (ASIC).

17. A method for detecting firmware corruption in a system having a host communicatively coupled to an electronic apparatus, said electronic apparatus having a hardware unit communicatively coupled to a non-volatile memory, said hardware unit including a boot ROM for:
querying said non-volatile memory for a signature word; and
determining whether said signature word is in proper form, wherein
if said signature word is not in proper form, then said firmware in said non-volatile memory is deemed to be corrupted, and
if said signature word is in proper form, then:
downloading firmware in said non-volatile memory to volatile memory; and
performing a checksum on said firmware downloaded to said volatile memory, wherein
if said checksum fails, then said firmware in said non-volatile memory is deemed to be corrupted, and
if said checksum passes, then executing said firmware downloaded to said volatile memory.

18. The method of claim 17, wherein the method is performed automatically at a power on reset (POR) of said electronic apparatus.

19. The method of claim 17, wherein the method is performed at a manual initiation by a user of said electronic apparatus.

20. The method of claim 17, wherein said hardware unit is an application specific integrated circuit (ASIC)

21. The method of claim 17 wherein the downloading the firmware occurs on a page basis and performing a checksum is repeated for each page of firmware downloaded.
